(19) United States
(12) Patent Application Publication
(10) Pub. No.: US 2006/0209799 A1
(43) Pub. Date: Sep. 21, 2006

(54) Unlicensed mobile access network (UMAN) system and method

(76) Inventors: Michael D. Gallagher, San Jose, CA (US); Milan Markovic, Pleasanton, CA (US); Rajeev Gupta, Sunnyvale, CA (US)

Correspondence Address: STATTLER, JOHANSEN, AND ADELI LLP, 1875 CENTURY PARK EAST SUITE 1360, CENTURY CITY, CA, 90067, US

(21) Appl. No.: 11/352,422

(22) Filed: Feb. 9, 2006

Related U.S. Application Data
(60) Provisional application No. 60/651,312, filed on Feb. 9, 2005.

(51) Int. Cl. H04L 12/66

(52) U.S. Cl. 370/352

(57) ABSTRACT

Some embodiments provide a system for handling communications between an unlicensed mobile access (UMA) network controller (UNC) and a licensed wireless communication system. The systems of these embodiments include a serving general packet radio service support node (SGSN) or a mobile switching center (MSC) that is communicatively coupled to the UNC. In such systems the UNC and the SGSN communicate utilizing a subset of a protocol standard message set. The protocol standard message set includes messages for handing discovery and registration, circuit switching domain and packet switching domain signaling, and circuit switching based data and packet switching based data. The subset for the SGSN is for handling packet switched domain signals and packet switching based data. The subset for the MSC is for handling circuit switched domain signals and circuit switching based data.

### CLAIM OF BENEFIT TO RELATED APPLICATIONS

This application claims the benefit of U.S. Provisional Application 60/651,312, entitled “An Improved Unlicensed Mobile Access Network (UMAN) System and Method” filed Feb. 9, 2005. This application is herein incorporated by reference

### FIELD OF THE INVENTION

The invention relates to telecommunication. More particularly, this invention relates to a technique for seamlessly integrating voice and data telecommunication services across a licensed wireless communication system and an unlicensed wireless communication system.

### BACKGROUND

Licensed wireless communications systems provide mobile wireless communications to individuals using wireless transceivers. Examples of licensed wireless communications systems include public cellular telephone systems, Personal Communication Services (PCS) telephone systems, etc. Examples of wireless transceivers include cellular telephones, PCS telephones, wireless-enabled personal digital assistants, wireless modems, etc.

Licensed wireless communication systems use wireless signal frequencies that are licensed from governments. Large fees are paid for access to these frequencies. Expensive base station equipment is used to support communications on licensed frequencies. Base stations are typically installed approximately a mile apart from one another. As a result, the quality of service (voice quality and speed of data transfer) in wireless communication systems is considerably inferior to the quality of service afforded by landline (wired) connections. Thus the user of a licensed wireless communication system pays relatively high fees for relatively low quality service.

Landline connections are extensively deployed and generally perform at a lower cost with higher quality and higher speed data services. Landlines may include traditional wired telephone lines or wired connections to the Internet.

In the past few years, the use of unlicensed wireless communication systems to facilitate mobile access to landline-based networks has seen rapid growth. For example, such unlicensed wireless communication systems may support wireless communication based on the IEEE 802.11a, b or g standards (WiFi), or the Bluetooth™ standard. The mobility range associated with such systems is typically on the order of 100 meters or less. A typical unlicensed wireless communication system includes a base station comprising a wireless access point (AP) with a physical connection (e.g., coaxial, twisted pair, or optical cable) to a landline-based network. The AP has a RF transceiver to facilitate communication with a wireless handset that is operative within a modest distance of the AP, wherein the data transport rates supported by the WiFi and Bluetooth™ standards are much higher than those supported by the aforementioned licensed wireless communication systems. Thus, this option provides higher quality services at a lower cost, but the services only extend a modest distance from the base station.

Currently, technology is being developed to integrate the use of licensed and unlicensed wireless communication systems in a seamless fashion, thus enabling a user to access, via a single handset, an unlicensed wireless communication system when within the range of such a system, while accessing a licensed wireless communication system when out of range of the unlicensed wireless communication system. In order to support more rapid implementation by various vendors, a standardized set of messages for performing various functions, such at registration, channel activation, handover, and the like are needed.

One such set of standards, the Unlicensed Mobile Access (UMA) specifications are based on the use of the “A interface” and “Gb interface” between the UMA network (UMAN) and licensed wireless communication system. The use of A and Gb interfaces has the desirable property that UMAN support can be added to a mobile network without modifications to the core network.

In order to improve interoperability between products from various unlicensed mobile technology companies, the “Up interface” specification was created by the UMA group of companies and was then submitted to the Third Generation Partnership Project (3GPP) where it became an international standard. On 8th Apr. 2005, the 3GPP approved specifications for Generic Access to A/Gb interfaces for 3GPP Release 6. The Up interface standard in 3GPP is numbered TS 44.318. “Up” is the designation for the interface between the mobile station and the “network” where the Up interface protocol is to be used. The UMA terminology is used throughout this application; however, the invention is equally applicable to the 3GPP version of the Up interface standard. It will be clear to those of ordinary skill in the art that the Up standard may be modified in the future. It is anticipated that the interfaces and message sets described in this specification will change in accord with any future changes in the Up standard, while remaining within the scope of the invention.

FIG. 1 illustrates the connections among various parts of a system 100 for connecting a wireless device to a cellular phone system that includes a licensed wireless communication system and an unlicensed wireless communication system. In the system, there are components for connecting to the network through unlicensed wireless communication system and other components for connecting to the network through licensed wireless communication system. Both the licensed wireless communication system and unlicensed wireless communication system paths to the cell phone network include an unlicensed mobile access (UMA) enabled mobile station 105 (hereafter referred to as a “UMA device”). In the unlicensed wireless communications path, the UMA device 105 is communicatively coupled to an access point (AP) 107. The AP passes signals over an Internet Protocol (IP) network 110 to a UMA network controller (UNC) 115. The signals include the stack of protocol layers used by the Up-interface 120, as further described below by reference to FIG. 2. The UNC 115 connects to components of the licensed wireless communication system, such as a Serving General Packet Radio Service (GPRS) Switch Node (SGSN) 150 and a mobile switching center (MSC) 160. The UNC connects to the SGSN via a Gb interface 155 and to the MSC via an A interface 165. In some embodiments, the UNC 115 also connects to an Authorization, Authentication, and Accounting (AAA) server 195. As shown, the AAA server 195 is connected to the Home Location Register (HLR) 197.

In some embodiments the UNC 115 includes Security Gateway function 135, Control function 140, and Media Gateway function 145.

As mentioned above, the licensed wireless communication system path also includes the UMA device 105. For a connection that stays entirely within the licensed wireless communication system, the UMA device 105 connects wirelessly with a Base Transceiver Station (BTS) 180, which in turn connects to a Base Station Controller (BSC) 185. Collectively, the BTS 180 and the BSC 185 make up the Base Station Subsystem (BSS) 187.

The UMA device 105 could be a cellular phone, personal communication system (PCS) or other device that accesses the cellular system. It is also referred to as a mobile station (MS). The IP network 110 can be a private or public Internet connection, often broadband. The UMA device 105 could connect to the IP network through 802.11 or Bluetooth, or any other unlicensed wireless communication system protocol. This typically requires an AP 107, such as a wireless Internet hub.

The UNC 115 is a communication gateway between the unlicensed wireless communication system and the licensed wireless communication system. Among other functions, the UNC 115 translates audio data from the UMA device 105 from voice over IP (VoIP) 170 to time division multiplexing (TDM) 175 before passing it on to the MSC. This is necessary if the MSC 160 can only handle TDM 175 signals, but not VoIP signals.

In many implementations, VoIP uses the adaptive multirate voice coder (AMR), which uses a maximum of approximately twelve kilobits per second of bandwidth. The TDM 175 format uses approximately sixty-four kilobits per second of bandwidth. If the caller using the UMA device 105 in this system calls another person using the UNC 115 to access the mobile network, then the call must be translated from AMR to TDM, then re-translated from TDM back into AMR. There is some loss of signal quality in each translation.

The MSC 160 is a telephone switching center that connects cell phone towers, such as the BTS 180, to the public switched telephone network (PSTN) or to other parts of the licensed wireless communication system. In more recent applications, MSCs have started to be used to connect UNCs to the PSTN, parts of the cellular network and to other UNCs. MSCs are used primarily for voice data. The MSC 160 communicates with the UNC 115 using an A interface 165. The A interface is comprised of two types of interfaces, the BSSAP/SS7 190, which primarily deals with controlling the background signaling for a call, and the TDM 175 interface, which carries the voice or other data of a call. The MSC 160 communicates with the BSC 185 using an A interface 167. This is a different physical connection to the MSC than the A interface 165, but both use the same set of protocols.

The SGSN 150 primarily sends non-voice packet switched service data, such as e-mail, instant messages, or Internet information, back and forth to cellular phones and other UMA devices. Like the MSG 160, the SGSN 150 communicates with the UNC 115. However, the SGSN uses a Gb interface 155 rather than an A interface 165. The MSC 160 communicates with the BSC 185 using an Gb interface 157. This is a different physical connection to the MSC than the Gb interface 155, but both use the same set of protocols. The issue of double translation mentioned above, issues of speed of connections and other reasons, create a need in the art for a system in which an MSC and SGSN process Up interface messages natively.

### SUMMARY

Some embodiments provide a system for handling communications between an unlicensed mobile access (UMA) network controller (UNC) and a licensed wireless communication system. The systems of these embodiments include a serving general packet radio service support node (SGSN) or a mobile switching center (MSC) that is communicatively coupled to the UNC. In such systems the UNC and the SGSN communicate utilizing a subset of a protocol standard message set. The protocol standard message set includes messages for handing discovery and registration, circuit switching domain and packet switching domain signaling, and circuit switching based data and packet switching based data. The subset for the SGSN is for handling packet switched domain signals and packet switching based data. The subset for the MSC is for handling circuit switched domain signals and circuit switching based data.

Some embodiments provide, a method involving an unlicensed mobile access (UMA) system that has a UMA device, a UMA network controller (UNC), and a serving general packet radio service support node (SGSN). In the method the UMA system communicates with a core network comprising a mobile switching center (MSC). The method is for communicatively coupling the UMA device and the core network. The method includes using a protocol standard that carries audio data to communicatively couple the UNC and the UMA device. The method includes relaying a subset of messages of the first protocol standard from the UNC to the core network. The subset of messages is in a second protocol that is a subset of the first protocol. The first protocol standard includes a set of messages for performing discovery and registration operations; and the relaying is without translation of said set of messages of the first protocol.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a UMA system with standard A and Gb interfaces of some embodiments.

FIG. 2 illustrates the Up common signaling protocol architecture.

FIG. 3 illustrates an improved UMA System of some embodiments.

FIG. 4 illustrates the Circuit mode services signaling protocol architecture of some embodiments.

FIG. 5 illustrates the Circuit mode services data transmission protocol architecture of some embodiments.

FIG. 6 illustrates the Packet mode services signaling protocol architecture of some embodiments.

FIG. 7 illustrates the Packet mode services data transmission protocol architecture of some embodiments.

FIG. 8 illustrates a Hybrid UMA System of some embodiments.

FIG. 9 illustrates another Hybrid UMA System of some embodiments.

FIG. 10 illustrates a process that the UNC uses when it receives a Up message in some embodiments.

### DETAILED DESCRIPTION OF THE INVENTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

### SUMMARY

Some embodiments provide a system for handling communications between an unlicensed mobile access (UMA) network controller (UNC) and a licensed wireless communication system. The systems of these embodiments include a serving general packet radio service support node (SGSN) or a mobile switching center (MSC) that is communicatively coupled to the UNC. In such systems the UNC and the SGSN communicate utilizing a subset of a protocol standard message set. The protocol standard message set includes messages for handing discovery and registration, circuit switching domain and packet switching domain signaling, and circuit switching based data and packet switching based data. The subset for the SGSN is for handling packet switched domain signals and packet switching based data. The subset for the MSC is for handling circuit switched domain signals and circuit switching based data.

Some embodiments provide, a method involving an unlicensed mobile access (UMA) system that has a UMA device, a UMA network controller (UNC), and a serving general packet radio service support node (SGSN). In the method the UMA system communicates with a core network comprising a mobile switching center (MSC). The method is for communicatively coupling the UMA device and the core network. The method includes using a protocol standard that carries audio data to communicatively couple the UNC and the UMA device. The method includes relaying a subset of messages of the first protocol standard from the UNC to the core network. The subset of messages is in a second protocol that is a subset of the first protocol. The first protocol standard includes a set of messages for performing discovery and registration operations; and the relaying is without translation of said set of messages of the first protocol.

Some embodiments of the current invention allow a core mobile network (e.g. the MSC and SGSN) to process at least some Up protocol messages natively. This eliminates the need for an Up-to-A and Up-to-Gb interface protocol interworking functions in the UNC that in the prior art translated the Up protocol messages into A and Gb interface messages. The new functionality of the MSC and SGSN systems allows an improved UNC unencumbered by Media Gateway functions. The system also simplifies the implementation of the interface signaling functions by removing the need for signaling system 7 (SS7) signaling layers and reducing the number of messages required to support UMA network to core network connectivity.

Several more detailed embodiments of the invention are described in sections below. Section I provides an introduction to the Up interface protocol. The discussion in Section I is followed by a discussion of an improved UMA system in Section II. Next, Section III describes several hybrid UMA systems that only use part of improvements described in Section II. Several alternative embodiments are identified in Section IV. Next, Section V describes the UNC Application Part protocol that allows the UNC to relay Up messages to and from the licensed wireless communication system. Next, Section VI describes the Up subset messages used by some embodiments of the invention. Last, Section VII defines the abbreviations used in this application.

I. Introduction

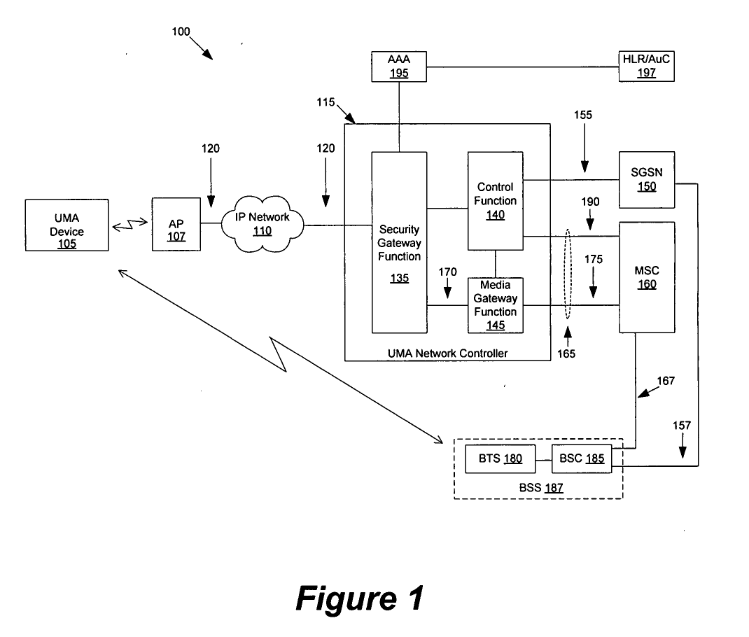

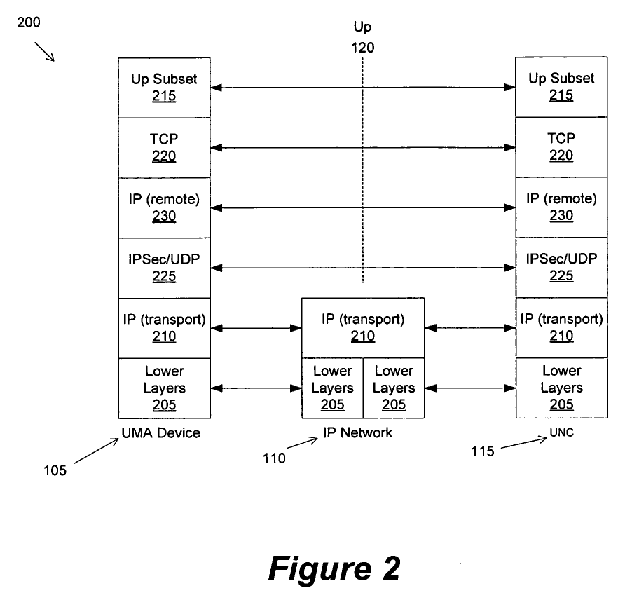

FIG. 2 illustrates the protocol architecture 200 for the Up interface common signaling protocol of the system illustrated in FIG. 1. FIG. 2 is an example of a network protocol architecture diagram. In particular, it shows a set of protocol stacks. A protocol stack identifies a series of protocol layers used for sending digital signals over a variety of devices. The layers represent different network protocols that are “wrapped” around each other in order to transfer a message. Devices along the path of the message are designed to either interact with the data of a particular set of layers, or to simply pass that data on in a manner instructed by data in the layers with which they are designed to interact. Often a particular set of layers must pass by a location (denoted by a vertical line) in the system in order for a message to be sent by a device on one side of that line to a device on the other side of that line. For a particular set of protocol layers, that line is called an interface. Devices with short protocol stacks transmit the data of the higher layers without interacting with that data. Such devices are said to be “transparent” to the higher protocol layers.

The Up common signaling architecture 200 includes lower layers 205 and IP transport layers 210 that are used by the IP network 110 as well as the UNC 115. As shown, the architecture also includes other layers (such as IPSec/UDP 225, IP (remote) 230, TCP 220, and Up Subset 215) that are transparent to the IP network.

In FIG. 2 the Up interface 120 must be used for the UMA device 105 to communicate with the UNC 115. As described above, the IP network 110 is transparent to all the layers above the IP (transport) layer 210.

One of the upper layers, which is used by the UNC, is the Up subset layer 215 described in more detail below. In FIG. 2, the TCP 220 connection associated with all signaling terminates on the UNC 115.

Some embodiments described below make use of a variety of subsets of the Up message set. Different components of some embodiments use different subsets. The subsets described below are examples of subsets used by some embodiments and other subsets may be used by other embodiments while remaining within the scope of the invention. Different subsets are disclosed in the discussions of FIGS. 2, 4, and 6 (Up subsets are identified as 215, 415, and 615 in these figures respectively). The description of these messages is given in Section VI below. One subset 215 of the Up interface protocol, i.e., part of UMA Radio Resources Management (RR), is processed by the UNC 115. This subset 215 of the Up interface protocol includes the following UMA messages that are shown below.

URR Discovery Request

URR Discovery Accept

URR Discovery Reject

URR Register Request
In some embodiments, described later, the UNC may also relay this message to the appropriate MSC and SGSN via Ucs-sig and Ups-sig, respectively; i.e. for notification purposes. No response is expected from the MSC/SGSN

URR Register Accept

URR Register Reject

URR Register Redirect

URR Register Update Uplink

URR Register Update Downlink

URR Deregister
In some embodiments, described later, the UNC may also relay this message to the appropriate MSC and SGSN via Ucs-sig and Ups-sig, respectively; i.e. for notification purposes. No response is expected from the MSC/SGSN

URR Keep Alive

URR Status
In some embodiments, described later, the UNC may also relay this message to the appropriate MSC and SGSN via Ucs-sig and Ups-sig, respectively; i.e. for notification purposes. No response is expected from the MSC/SGSN

The system illustrated in FIGS. 1-2 requires that the UNC translate commands using the Up interface protocol into commands using the Gb interface and the A interface standards. This allows the unlicensed wireless communication system to interact with the core network of the licensed wireless communication system without modifying the core network. On the other hand, other systems are available which offer other advantages, such as the embodiments described below.

Some embodiments of the invention are implemented in a UMA compliant system. A UMA compliant system is a system that complies with most or all of the requirements set forth in the UMA standards elaborated in the following UMA and 3rd Generation Partnership Project (3GPP) documents.
[UMA R] Unlicensed Mobile Access (UMA) User Perspective (Stage 1)
[UMA A] Unlicensed Mobile Access (UMA) Architecture (Stage 2)
[UMA P] Unlicensed Mobile Access (UMA) Protocols (Stage 3)
[08.02] 3GPP TS 08.02: “Base Station System—Mobile-services Switching Centre (BSS-MSC) interface; interface principles”
[08.06] 3GPP TS 08.06: “Signaling transport mechanism specification for the Base Station System—Mobile-services Switching Centre (BSS-MSC) interface”
[08.08] 3GPP TS 08.08: “Mobile-services Switching Centre—Base Station System (BSS-MSC) interface; Layer 3 specification.
[03.60] 3GPP TS 03.60: “General Packet Radio Service (GPRS); Service description; Stage 2”.
[08.18] 3GPP TS 08.18: “Base Station System—Serving GPRS Support Node (BSS-SGSN); BSS GPRS Protocol (BSSGP)”.
[SCTP] IETF RFC 2960: “Stream Control Transmission Protocol”.
[TS 44.318] Digital cellular telecommunications system (Phase 2+); Generic Access (GA) to the A/Gb interface; Mobile GA interface layer 3 specification (3GPP TS 44.318
   II. Improved UMA System

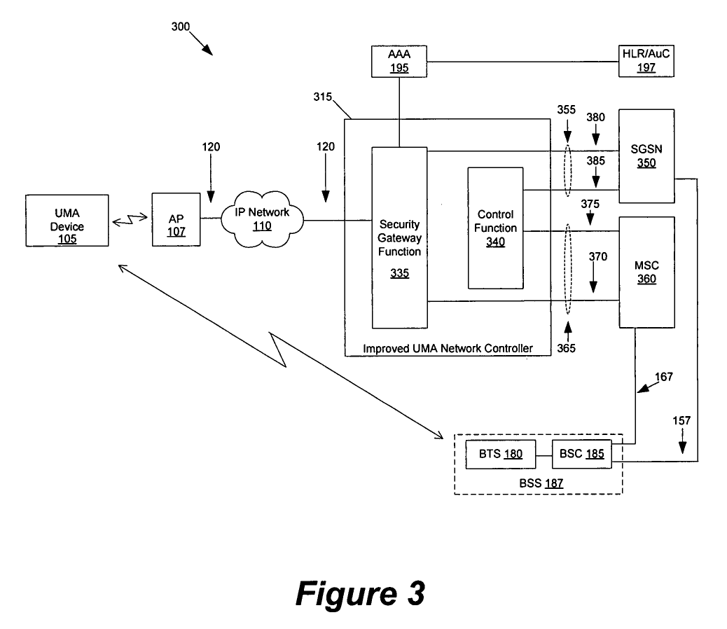

FIG. 3 illustrates a communications system 300 of some embodiments of the invention. This system has a UMA device 105, which uses an Up interface 120 to connect to a UNC 315 over an IP network 110. The UNC 315 includes a security gateway function 335 and a control function 340. The UNC 315 communicates with the MSC 360 via an Up circuit mode services (Ucs) 365 interface. The UNC 315 communicates with an SGSN 350 using an Up packet mode services (Ups) 355 interface. As in FIG. 1, the licensed wireless communication system components connecting the UMA device 105 to the MSC 360 include a BTS 180 which in turn connects to a BSC 185, which connects to the MSC 360 and the SGSN 350 through an A and GB interface respectively. The following sections describe the components of this system in more detail.

A. Ucs Interface

The Ucs interface 365, as mentioned above, connects the UNC 315 to the MSC 360. The Ucs interface 365 includes two components, the Ucs-data interface 370 and the Ucs signaling (Ucs-sig) interface 375. The Ucs-data interface 370 connects the security gateway function 335 of the UNC 315 to the MSC 360. The Ucs-data interface 370 carries the circuit-switched service user data (i.e., RTP and RTCP) packets. The Ucs signaling (Ucs-sig) interface 375 connects the control function 340 of the UNC to the MSC 360. The Ucs signaling (Ucs-sig) interface 375 carries the circuit-switched service related signaling information.

1. Ucs-sig Interface

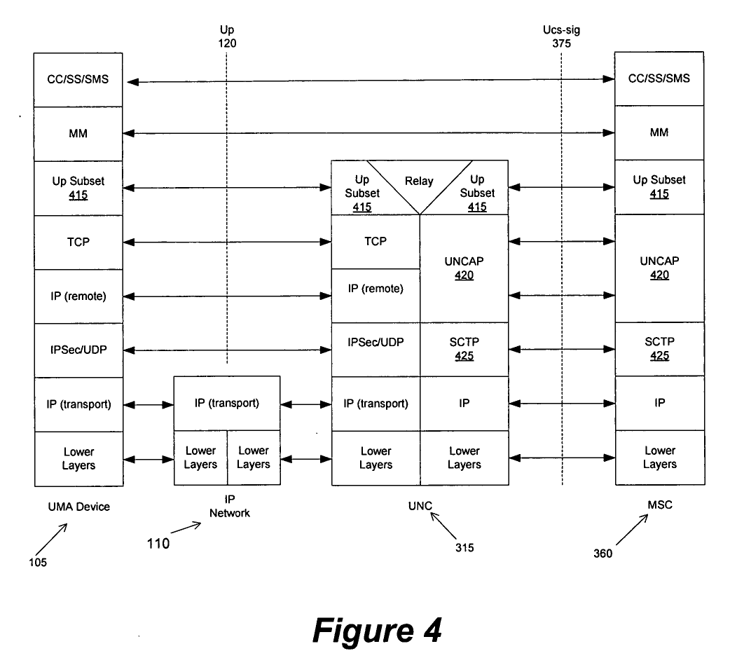

The Ucs-sig interface 375 is part of the Ucs interface as mentioned above. The Ucs-sig interface 375 is used primarily for messages used to control the background signaling functions that allow a cell phone call to happen. These messages are sent using the circuit mode services signaling protocol architecture. FIG. 4 illustrates the circuit mode services signaling protocol architecture of some embodiments. This figure shows that the UNC 315 connects to the MSC 360 through the Ucs-sig interface 375. The Up subset 415 layer is relayed by the UNC 315 on to the MSC 360. The MSC 360 uses the Up subset 415 protocol layer in its protocol stack. In FIG. 4, in the MSC protocol stack, the Up subset 415 is over the UNC application part protocol (UNCAP) 420 and stream control transmission protocol (SCTP) 425 layers. These features are described in more detail below.

The UMA device 105 connects to the UNC 315 through an IP network 110. The IP network 110 is similar to the IP network 110 of FIGS. 1-2. The IP network 110 could be a public or private IP network, it could be a generic Internet connection, including a broadband connection. As with the protocol architecture described in FIG. 2, the IP network 110 is transparent to protocol layers above the IP (transport) level. Some embodiments support IPv4 (version 4 of the Internet Protocol). Some other embodiments support other versions of Internet Protocol such as IPv6. Similarly to FIG. 2, the UMA device 105 in FIG. 4, connects to the UNC 315 through the Up interface 120.

The Up subset 415 layer is a protocol layer that uses a subset of the commands available under the Up standard described in the Introduction Section. Unlike in the system illustrated in FIGS. 1-2, the Up subset 415 messages in FIG. 4 are relayed by the UNC 315 to the MSC 360. The presence of the Up subset 415 protocol layer in the MSC 360 protocol layer stack indicates that the MSC 360 understands the Up subset 415 protocol messages. The position of the Up subset 415 protocol layer (above the UNCAP and SCTP 425 layers) in the protocol stack of the MSC 360 shows that the Up subset 415 protocol layer messages sent using the Ucs-sig interface are encapsulated in the UNCAP protocol and sent over an SCTP connection between the UNC 315 and the MSC 360. The UNCAP protocol is further described in Section V. The SCTP procedures are well known in the art and some embodiments described in this specification use them to leverage the built-in SCTP features of avoiding head-of-line blocking (for multiple UMA device transactions over a common transport association), multi-homing, failure detection and recovery, etc. In some embodiments, the UNCAP protocol uses a SCTP Payload Protocol Identifier value that is assigned for UNCAP purposes. This identifies the SCTP payload as an UNCAP message. The Up subset 415 protocol layer on either side of the Ucs-sig 375 interface indicates that the messages crossing that location in the system must include the Up subset 415 protocol layer.

The circuit mode services signaling subset 415 of the Up interface protocol includes the following UMA messages that are shown below.

URR Request

URR Request Accept

URR Request Reject

URR Ciphering Mode Command

URR Ciphering Mode Complete

URR Activate Channel

URR Activate Channel Ack

URR Activate Channel Complete

URR Activate Channel Failure

URR Channel Mode Modify

URR Channel Mode Modify Ack

URR Release

URR Release Complete

URR Clear Request

URR Handover Access

URR Handover Complete

URR Uplink Quality Indication

URR Handover Required

URR Handover Command

URR Handover Failure

URR Paging Request

URR Paging Response

URR Uplink Direct Transfer

URR Classmark Enquiry

URR Classmark Change

URR Synchronization Information

URR Register Request
Note that the UNC may relay this message to the MSC for notification purposes

URR Deregister
Note that the UNC may relay this message to the MSC for notification purposes

URR Status
Note that the UNC may relay this message to the MSC if the PDU in error is associated with the Up circuit mode services signaling subset

URR GPRS Suspension Request
Note that this message is relayed to the MSC and SGSN by the UNC. If received, the MSC is responsible for including the GPRS Resumption IE in the URR Release message that ends the circuit mode session.

2. Ucs-Data Interface

The Ucs-data interface 370 is part of the Ucs interface mentioned above. The Ucs-data interface 370 is used by some embodiments to pass data between the UNC 315 and the MSC 360. The data sent using the Ucs-data interface 370 may include speech (or other audio) data, other types of data such as fax or other forms of data defined in UMA standard. This data is sent using the circuit mode services data transmission protocol architecture. The Ucs-data interface 370 is part of that protocol architecture.

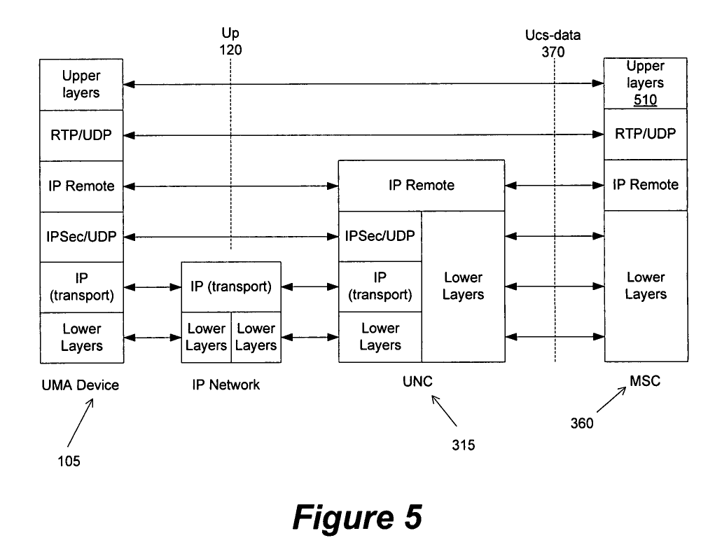

FIG. 5 illustrates the circuit mode services data transmission protocol architecture. The architecture includes a protocol stack of the MSC 360. The protocol stack includes upper layers 510. The upper layers 510 may contain speech, circuit switched data, fax, or other forms of user data defined in UMA. The Upper layer data flows over the Up interface within RTP packets which are routed to and from the MSC over the Ucs-data interface by the UNC (e.g., the Security Gateway function).

In some embodiments, the upper layers may contain data in the AMR format previously mentioned. In some embodiments, calls can go from a UMA device 105, through the unlicensed wireless communication system to the MSC 360, and then through the same or another unlicensed wireless communication system to reach a second UMA device. The ability of the MSC 360 to handle the Up subset layer protocol, as mentioned above, allows such calls to go from one UMA device to another through the MSC without changing from the AMR format to the TDM format and back to AMR. This saves processing time, eliminates the signal degradation that is inevitable when translating audio from one format to another, and removes the need for a Media Gateway 145 from the UNC 315.

B. The Ups Interface

The Ups interface 355, shown in FIG. 3, performs similar functions for connecting the UNC 315 to the SGSN 350 as the Ucs interface 365 performs for connecting the UNC 315 to the MSC 360. As described above, the SGSN 350 primarily sends non-voice packet switched service data, such as e-mail, instant messages, or Internet information, back and forth to cellular phones and other wireless communication devices. Currently SGSNs are also used to connect to unlicensed wireless communication systems. Similar to the Ucs interface 365, the Ups interface 355 includes two components. The Ups interface 355 includes the Ups-data interface 380 that connects the security gateway function 335 of the UNC 315 to the SGSN 350, and the Ups signaling (Ups-sig) interface 385 that connects the control function 340 of the UNC to the SGSN 350. The Ups-data interface carries the packet-switched service user data packets and the Ups-sig interface carries the packet-switched services (i.g., GPRS) related signaling information. These interfaces are further described below.

1. Ups-Sig Interface

The Ups-sig interface 385 is part of the Ups interface as mentioned above. The Ups-sig interface 385 is used primarily for messages used to control the background signaling functions that allow a wireless device to send and receive packet switched service data such as e-mail and instant messages. The packet mode services signaling protocol architecture is used to pass these control messages from the UMA device 105 to the SGSN 350. The Ups-sig interface is part of the packet mode services signaling protocol architecture.

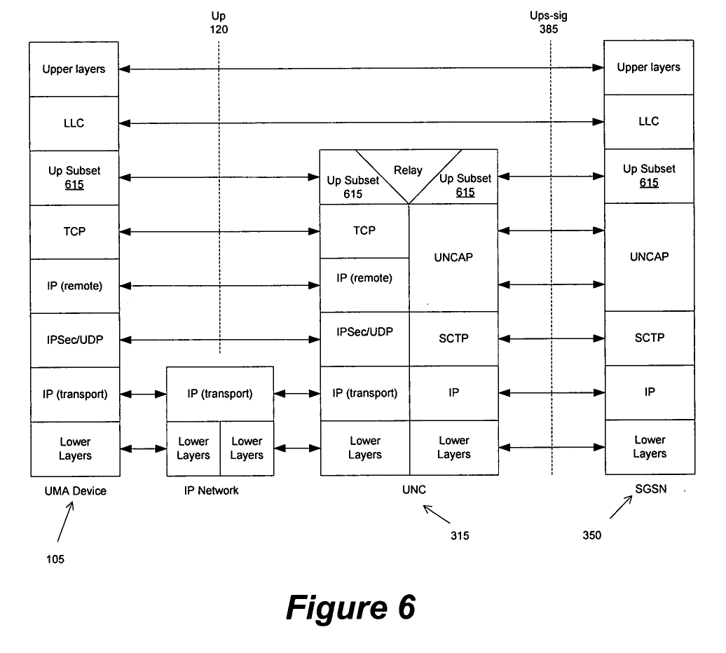

FIG. 6 illustrates the packet mode services signaling protocol architecture of some embodiments. This figure shows that the UNC 315 connects to the SGSN 350 through the Ups-sig interface 385. The Up subset 615 layer is a protocol layer that uses a subset of the commands available under the Up standard. The presence of the Up subset 615 protocol layer in the SGSN 350 protocol layer stack indicates that the SGSN 350 understands the Up subset 615 protocol messages. The position of the Up subset 615 protocol layer (above the UNCAP and SCTP 425 layers) in the protocol stack of the SGSN 350 shows that the Up subset 615 protocol layer messages sent using the Ups-sig interface are encapsulated in the UNCAP protocol and sent over an SCTP connection between the UNC 315 and the SGSN 350. The UNCAP protocol is further described below. The Up subset 615 protocol layer on either side of the Ups-sig 385 interface indicates that the messages crossing that interface in the system must include the Up subset 615 protocol layer.

The packet mode services signaling protocol related message set includes the UMA messages below.

URLC Data
Note that all LLC frames except unconfirmed information (UI format) frames for SAPIs 3, 5, 9, and 11 are transferred using this message

URLC Activate UTC Request

URLC Activate UTC Ack

URLC Deactivate UTC Request

URLC Deactivate UTC Ack

URLC PS Page

URR GPRS Suspension Request
Note that although this is classified as a UMA-URR message (versus UMA-URLC), it is relayed to the SGSN by the UNC, in addition to the MSC.

URR Register Request
Note that the UNC may relay this message to the SGSN for notification purposes

URR Deregister
Note that the UNC may relay this message to the SGSN for notification purposes

2. Ups-Data Interface

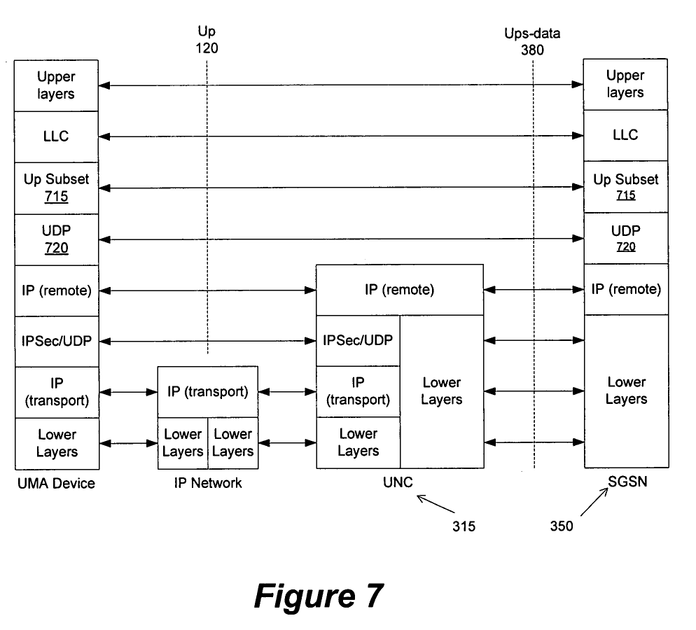

The Ups-data interface 380 is part of the Ups interface mentioned above. The Ups-data interface is used by some embodiments to pass packet-switched service data such as e-mail, instant messages, or Internet information between the UNC 315 and the SGSN 350. These types of data are passed using the packet mode services data transmission protocol architecture. The Ups-data interface is part of the packet mode services data transmission protocol architecture. FIG. 7 illustrates the packet mode services data transmission protocol architecture. The figure shows a protocol stack of the SGSN 350 that includes Up Subset 715 layer over the UDP layer 720. As shown in the figure, the Up subset 715 layer is above the top layer of the UNC 315. This indicates that the UNC 315 is transparent to the Up subset 715 used by the Ups-data interface. Although in these embodiments the UNC 315 is transparent to Up subset 715, the UNC 315 may not be transparent to other subsets of the Up interface standard. In this embodiment, the UDP-encapsulated UMA-RLC messages are routed to and from the SGSN over the Ups-data interface by the UNC 315 (e.g. by the security gateway function). The Up subset 715 for packet mode services data transmission includes the UMA messages shown below.

URLC Unidata

URLC DFC Request

URLC UFC Request

III. Hybrid UMA Systems

Some embodiments employ a hybrid UMA system. A hybrid UMA system is one in which either the MSC or the SGSN systems, but not both, handle Up interface protocol messages. In a hybrid system, the interface corresponding to the system which handles the Up interface protocol messages is replaced with the Ucs or Ups interface, as appropriate.

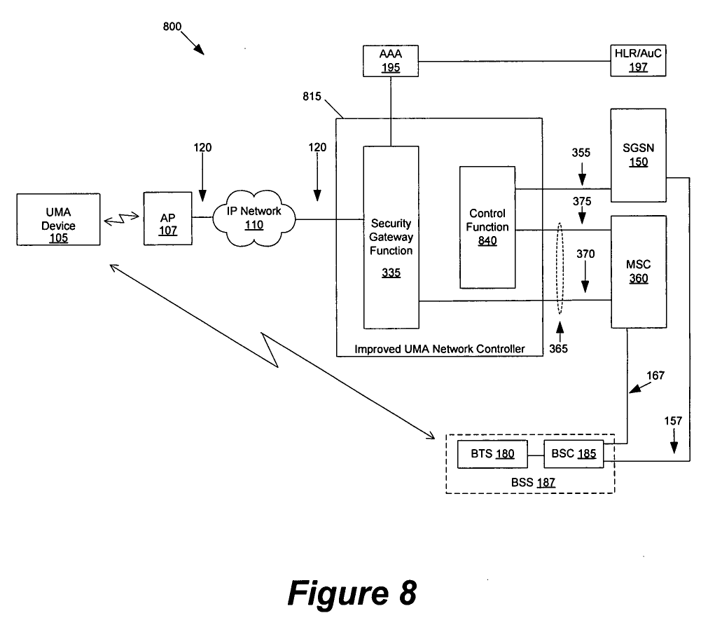

FIG. 8 illustrates the hybrid system 800 of some embodiments using a standard Gb interface between the control function 840 of the UNC 815 and the SGSN 150. The functionality of the SGSN 150 in this hybrid system may be identical to that of the SGSN 150 in FIG. 1. The MSC 360 of FIG. 8, however, uses the Ucs interface in the way illustrated in FIGS. 3, 4 and 5. For instance the Ucs-sig interface may use the same Up subset 215 messages listed in Sub-section II.A.1 above.

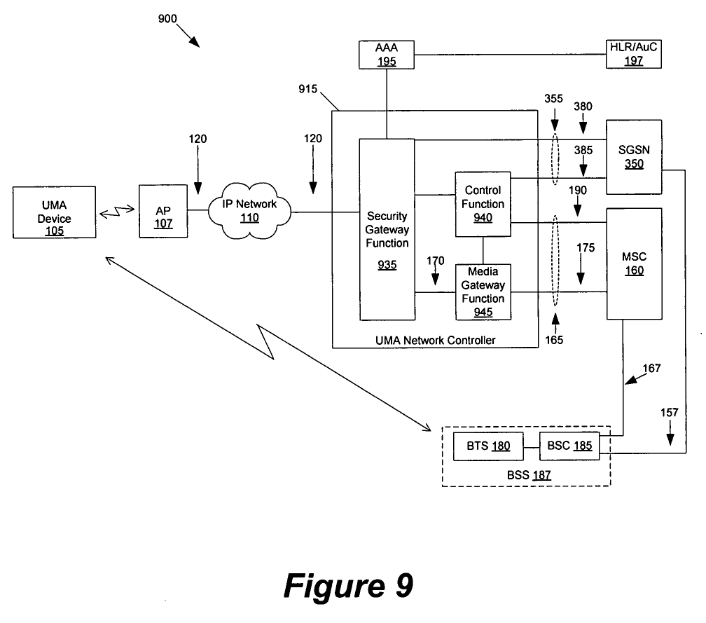

FIG. 9 illustrates the hybrid system 900 of some embodiments using a standard A interface between the control function 940 and Media Gateway function 945 of the UNC 915 and the MSC 160. The functionality of the MSC 160 in this hybrid system may be identical to that of the MSC 160 in FIG. 1. The SGSN 350 of FIG. 9, however, uses the Ups interface in the way illustrated in FIGS. 3, 6 and 7. For instance the Ups-data interface may use the same Up subset 715 described in Sub-section II.B.2 and the Ups-sig interface may use the same Up subset 615 described in Sub-section II.B.1.

IV. Alternative Embodiments

There are many alternative embodiments of the invention which will be obvious to those of ordinary skill in the art. The following examples are just a few of the possible features of some alternate embodiments.

The UNC may be realized as a single product with both security gateway functions and control functions, or as separate products. Each separate product fulfilling all or part of the security gateway functions and control functions.

The MSC described in this document may be a 3GPP “Release 1999” MSC (i.e., a traditional monolithic implementation), or a 3GPP “Release 4” MSC Call Server together with a Media Gateway (i.e., a soft switch implementation), or some other variant of an MSC.

A person of ordinary skill in the art will realize that the figures depicting the architecture are logical diagrams only and it is within the scope of the invention for the physical interfaces connecting one system with another to be in a different layout than that shown. For example, the various interfaces shown connecting to the UNC could all use the same physical interface (e.g. an Ethernet interface to an external Ethernet switch to which both the SGSN and the MSC are connected.

V. UNCAP Protocol

The UNC Application Part (UNCAP) protocol allows the UNC to relay Up messages to and from the MSC and SGSN and to identify the UMA Device that either originated the message or is the intended recipient of the message.

A. Messages

Table I lists the UNCAP message identifier values.

TABLE 1
UNCAP message identifiers

| UNCAP MESSAGE NAME | MESSAGE ID |
|---|---|
| Uplink Relay | 0x00 |
| Downlink Relay | 0x01 |

1. Uplink Relay

The Uplink Relay message may be sent by the UNC to the MSC (or SGSN). Table 2 lists the parameters (also known as “Information Elements”) of the Uplink Relay message.

TABLE 2
Uplink Relay message

| | | TYPE/ | | | | |
|---|---|---|---|---|---|---|
| | INFORMATION | REFERENCE | PRESENCE | | | |
| IEI | ELEMENT | (NOTE 1) | (NOTE 1) | FORMAT | LENGTH | VALUE |
| | Version | Version | M | V | 1 | Version = 1 |
| | Uplink Relay | Message | M | V | 1 | See Table 1 |
| | Message Type | Identifier | | | | |
| | IMSI | Mobile Identity | M | V | 9 | Coded as in 3GPP TS |
| | | | | | | 24.008, not including |
| | | | | | | IEI and length |
| | Cell Identification | Cell | M | V | 8 | Coded as in 3GPP TS |
| | | Identification | | | | 08.08, not including |
| | | | | | | IEI and length |
| | Encapsulated Up | Encapsulated Up | M | V | Variable | Contains the entire |
| | Message | Message | | | | Up message; see |
| | | | | | | [UMA P] |

2. Downlink Relay

The Downlink Relay message may be sent by either the MSC or the SGSN to the UNC. Table 3 lists the parameters (also known as “Information Elements”) of the Downlink Relay message.

TABLE 3
Downlink Relay message

| | | TYPE/ | | | | |
|---|---|---|---|---|---|---|
| | INFORMATION | REFERENCE | PRESENCE | | | |
| IEI | ELEMENT | (NOTE 1) | (NOTE 1) | FORMAT | LENGTH | VALUE |
| | Version | Version | M | V | 1 | Version = 1 |
| | Downlink Relay | Message | M | V | 1 | See Table 1 |
| | Message Type | Identifier | | | | |
| | IMSI | Mobile Identity | M | V | 9 | Coded as in 3GPP TS |
| | | | | | | 24.008, not including |
| | | | | | | IEI and length |
| | Encapsulated Up | Encapsulated Up | M | V | Variable | Contains the entire |
| | Message | Message | | | | Up message; see |
| | | | | | | [UMA P] |

B. Procedures

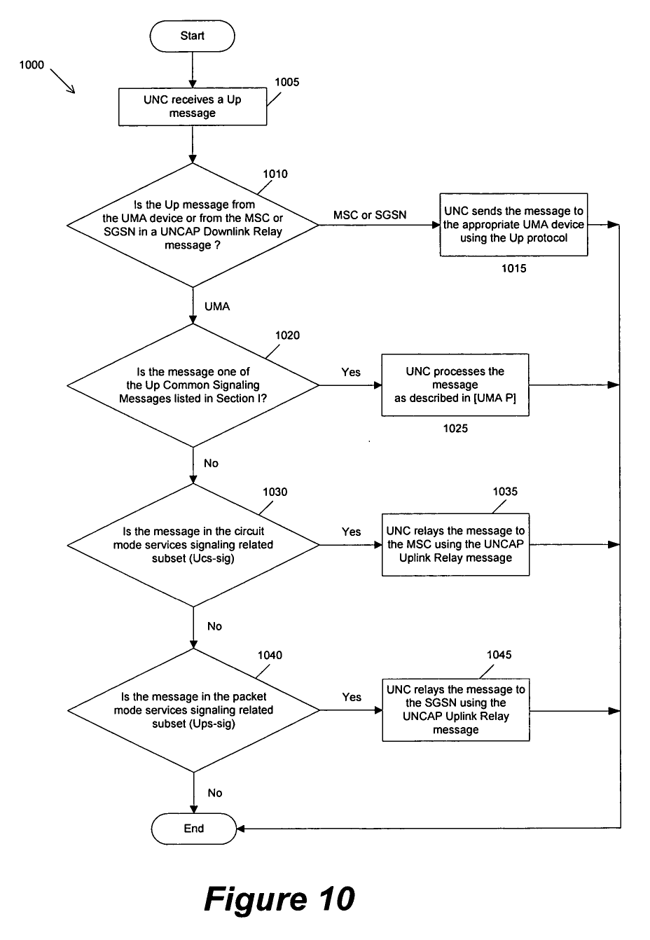

FIG. 10 illustrates a process 1000 that the UNC of some embodiments uses when it receives (at 1005) a Up message. The UNC determines (at 1010) whether the message is from a UMA device or from an MSC or an SGSN in a UNCAP Downlink Relay message. If the message is from an MSC or SGSN then the UNC (at 1015) sends the message to the appropriate UMA device using the Up protocol. If the message is from a UMA device, then the UNC determines (at 1020) whether the message is one of the Up common signaling messages listed is Section I. If so, then the UNC processes (at 1025) the message as described in [UMA P]. Otherwise, the UNC determines (at 1030) whether the message is in the circuit mode services signaling related subset of the Up interface protocol (i.e., the Ucs-sig related subset). If so, the UNC relays (at 1035) the message to the MSC using the UNCAP Uplink Relay message. Otherwise, the UNC determines at (1040) whether the message is in the packet mode services signaling related subset of the Up interface protocol (i.e., the Ups-sig subset). If so, then the UNC relays (at 1045) the message to the SGSN using the UPCAP Uplink Relay message.

VI. Up Subset URR Messages

This section defines the Up subset messages used by the embodiments described above. As described in the preceding sections, each interface may use only a subset of these messages. Each group of URR messages are for a particular procedure. In the following paragraphs, each procedure is defined following by a description of each individual message utilized in the procedure. The term MS is used to denote the mobile station or the UMA device described above. When a message is defined to be sent from the MS to the UNC or vice versa, it is implied that the message is sent through the access point (AP) and the IP network as described in previous sections.

A. The Discovery Procedure

The Discovery procedure is performed between the MS and a provisioning UNC. The purpose of the Discovery procedure is to find the needed information about a Default UNC. The Discovery procedure includes the following messages:
URR Discovery Request—sent from the MS towards the Provisioning UNC to initiate the Discovery procedure
URR Discovery Accept—sent from the Provisioning UNC to the MS if the Discovery request is accepted
URR Discovery Reject—sent from the Provisioning UNC to the MS if the Discovery request is rejected

B. The Registration Procedure

The Registration procedure is performed between the MS and the UNC (Default or Serving UNC) to optionally redirect the MS to the correct UNC and then register the MS for UMA services on that UNC. The Registration procedure includes the following messages:
URR Register Request—sent from the MS to the Default or Serving UNC to initiate the Registration procedure (in some embodiments, the UNC may also relay this message to the appropriate MSC and SGSN via Ucs-sig and Ups-sig, respectively; i.e. for notification purposes. No response is expected from the MSC/SGSN)
URR Register Accept—sent from the Default or Serving UNC to the MS if the Registration request is accepted
URR Register Reject—sent from the Default or Serving UNC to the MS if the Registration request is rejected
URR Register Redirect—sent to the MS if the MS has to be redirected to another UNC

C. Registration Update Procedure

The Registration Update procedure is used by the MS after the MS has successfully registered to a UNC whenever the AP or the overlapping GSM coverage changes. The UNC may also use the Registration Update towards the MS.
URR Register Update Uplink—sent by the MS to the UNC when the MS has successfully registered to UNC and detects that either the AP has changed, or when the MS enters GSM coverage after reporting no coverage during UMA registration
URR Register Update Downlink—the UNC may at any time send this message a MS that is registered. This happens, e.g., because of change in the UNC System Information
URR Deregister—sent from the UNC to the MS if the UNC rejects the Registration Update (in some embodiments the UNC may also relay this message to the appropriate MSC and SGSN via Ucs-sig and Ups-sig, respectively; i.e. for notification purposes. No response is expected from the MSC/SGSN)

D. Keep Alive Mechanism—The Keep Alive mechanism is initiated by the MS when the MS receives URR Register Accept message. The Keep Alive mechanism is initiated by starting timer TU3906. This mechanism includes the following message:
URR Keep Alive—sent by the MS when the MS receives URR Register Accept message

E. URR Status—This message is utilized to report the URR status (In some embodiments, the UNC may also relay this message to the appropriate MSC and SGSN via Ucs-sig and Ups-sig, respectively; i.e. for notification purposes. No response is expected from the MSC/SGSN. Also the UNC may relay this message to the MSC if the PDU in error is associated with the Up circuit mode services signaling subset

F. URR Connection Establishment

The URR connection is a logical connection between the MS and the UNC. It is established when the upper layers in the MS request to enter dedicated mode. The URR Connection establishment includes the following messages:
URR Request—sent from the MS to the UNC to initiate URR connection
URR Request Accept—sent from the UNC to the MS if the UNC accepts the URR connection establishment request
URR Request Reject—sent from the UNC to the MS if the UNC rejects the URR connection establishment request

G. Ciphering Configuration Procedure

The Ciphering configuration procedure is used by the network to set the ciphering mode, i.e., whether or not the transition is ciphered, and if so which algorithm is used. This information is not used when the URR-layer is the serving enitity in the MS, but shall be stored in the MS for possible future use after a handover from UMAN during the same upper layer transaction. the Ciphering configuration procedure includes the following messages:
URR Ciphering Mode Command—sent from the UNC to the MS to initiate the ciphering mode setting procedure
URR Ciphering Mode Complete—sent from the MS to the UNC after the appropriate action on the URR Ciphering Mode Command has been taken

H. Traffic Channel Assignment

Traffic Channel assignment is used by the UNC to assign a traffic channel to the MS and includes the following message:
URR Activate Channel—sent by the UNC to the MS to configure a traffic channel on receiving an Assignment Request from the MSC
URR Activate Channel Ack—sent by the MS to the UNC to acknowledge the receipt of the URR Activate Channel
URR Activate Channel Complete—sent by the UNC to the MS if the channel assignment is successful
URR Activate Channel Failure—sent by the UNC to the MS if the channel assignment fails

I Channel Mode Modify Procedure

This procedure is initiated by the UNC and allows the network to request the MS to modify configuration used for an active channel. this procedure includes the following messages:
URR Channel Mode Modify—sent from the UNC to the MS to initiate Chanel Mode Modify procedure
URR Channel Mode Modify Ack—sent from the MS to the UNC after the MS receives the URR Channel Mode Modify message and performs the requested modifications to the active channel

J. Release of URR

This procedure is used to release the URR connection and includes the following message:
URR Release—sent by the UNC to the MS to command the MS to release the URR and any traffic channel resources and instruct the MS to leave URR-Dedicated state
URR Release Complete—sent by the MS to the UNC after the receipt of the URR Release command by the UNC
URR Clear Request—sent by the MS to the UNC if the MS needs to release the URR connection and signaling connection to the core network

K. Handover to UMAN Procedure

This procedure is initiated when the source radio access technology (e.g., GERAN) orders the MS to make handover to UMAN. This procedure includes the following messages:
URR Handover Access—sent by the MS to the UNC to initiate the handover after the MS is commanded by the radio access technology to make a handover to UMAN
URR Handover Complete—sent by the MS to the UNC when a traffic channel assignment was successfully completed

L. Hanover from UMAN Procedure

This procedure is used to transfer, upon request from the MS (and under the control of the UMAN), a connection between MS and UMAN to another radio access technology (e.g., GERAN). This procedure includes the following messages:
URR Uplink Quality Indication—sent by the UNC to the MS to indicate the uplink quality
URR Handover Required—sent from the MS to the UNC to trigger the handover from UMAN
URR Handover Command—sent from the UNC to the MS when the core network (CN) grants the handover request
URR Handover Failure—sent from the MS to the UNC if the MS does not succeed in establishing a connection to the target radio access technology

M. Paging for CS Domain

The UNC initiates this procedure when it receives a Paging Request from the MSC or a Paging CS request from the SGSN. This procedure includes the following messages:
URR Paging Request—sent from the UNC when it receives a Paging Request from the MSC or a Paging CS request from the SGSN
URR Paging Response—sent from the MS to the UNC if the mobile identity in the URR Paging Request matches any of valid identities of the MS and the MS is in URR-IDLE state

N. Upper layer message forwarding by the MS

The MS initiates this procedure when the upper layers request a transfer of a non-access stratum message. This procedure includes the following message:
URR Uplink Direct Transfer—sent from the MS to the UNC to initiate the URR Uplink Direct Transfer in URR-DEDICATED state when the upper layers request a transfer of a non-access stratum message

O. Classmark Indication

The Classmark indication procedure is used by the UNC to requires more information about the MS's capabilities. This procedure includes the following messages:
URR Classmark Enquiry—sent from the UNC to the MS to initiate the classmark interrogation procedure when the UNC requires more information about the MS's capabilities
URR Classmark Change—sent from the MS to the UNC on receipt of the URR Classmark Enquiry message or in case of “early classmark sending” procedure based on the system information indication received in a URR Register Accept message

P. URLC Transport Channel

The URLC Transport Channel is defined as a UDP based point to point connection between the MS and the UNC utilized for GPRS user data transfer. A URLC Transport Channel can be initiated by either the MS or the UNC and includes the following messages:
URLC Data—is used to exchange the URLC data between the MS and the UNC (all LLC frames except unconfirmed information (UI format) frames for SAPIs 3, 5, 9, and 11 are transferred using this message)
URLC Activate UTC Request—sent from the MS to the UNC to or from the UNC to MS to initiate URLC TC
URLC Activate UTC Ack—sent from the MS to the UNC or from the UNC to the MS to acknowledge the URLC Activate UTC Request
URLC Deactivate UTC Request—sent from the MS to the UNC or from the UNC to the MS to request the deactivation of the transport channel
URLC Deactivate UTC Ack—sent from the MS to the UNC or from the UNC to the MS to acknowledge the URLC Deactivate UTC Request

Q. Packet Paging for Packet Service

This procedure is used to page a UMAN registered MS and includes the following messages:
URLC PS Page—Upon receiving a Paging Request from the SGSN for UMAN registered MS, the UNC sends the URLC PS Page message to the MS via the signaling TCP session
URR GPRS Suspension Request—while transmitting to dedicated mode and if unable to support simultaneous CS and PS services, the MS requests the suspension of the downlink GPRS data transfer by sending this message to the UNC (although this is classified as a UMA-URR message (versus UMA-URLC), it is relayed to the SGSN by the UNC, in addition to the MSC). In some embodiments this message is relayed to the MSC and SGSN by the UNC. If received, the MSC is responsible for including the GPRS Resumption IE in the URR Release message that ends the circuit mode session

R. URLC GPRS User Data Transport

Both the MS and the UNC can initiate GPRS user data transfer automatically by using URLC Unidata service. The URLX GPRS User Data Transport includes the following message:
URLC Unidata—sent from either the UNC or the MS to initiate the service

S. MS Initiated Downlink Flow Control

The MS initiated downlink flow control procedure is based on standard GPRS downlink flow control mechanism enhanced for the UMA service. This procedure includes the following messages:
URLC DFC Request—sent from the MS to the UNC to when the downlink flow control condition is detected. The MS starts timer TU4003 at the same time

T. Uplink Flow Control Procedure

The Uplink Flow Control procedure is used to dynamically manage sharing of the available Gb interface bandwidth. This procedure includes the following message:
URLC UFC Request—sent from the UNC to the MS to initiate the Uplink Flow Control procedure

U. URR Synchronization Information—This message is sent to exchange the URR Synchronization information

VII. Abbreviations

| | |
|---|---|
| 3GPP | The 3rd Generation Partnership Project |
| AAA | Authorization, Authentication and Accounting |
| AP | Access Point |
| BSC | Base station Controller |
| BSS | Base Station Subsystem |
| BTS | Base Transceiver Station |
| CM | Connection Management |
| GSM | Global System for Mobile Communication |
| HLR | Home Location Register |
| IP | Internet Protocol |
| MG | Media Gateway |
| MM | Mobility Management |
| MS | Mobile Station |
| MSC | Mobile Switching Center |
| PCM | Pulse Code Modulation |
| PLMN | Public Land Mobile Network |
| RR | Radio Resource Management |
| RTCP | Real Time Control Protocol |
| RTP | Real Time Protocol |
| SCTP | Stream Control Transmission Protocol |
| SGSN | Serving GPRS Switch Node |
| SGW | Security Gateway |
| SS7 | Signaling System 7 (a set of layered protocols that are |
| | used to move signaling information between |
| | telecommunications systems in a highly reliable fashion) |
| TCP | Transmission Control Protocol |
| TDM | Time Division Multiplex |
| UDP | User Datagram Protocol |
| UMA | Unlicensed Mobile Access |
| UMAN | UMA Network |
| UNC | UMA Network Controller |
| UNCAP | UNC Application Part |
| URR | UMA Radio Resource Management |

We claim:

1. In an unlicensed mobile access (UMA) system having a UMA device a UMA network controller (UNC), wherein said UMA system communicates with a core network comprising a mobile switching center (MSC) and a serving general packet radio service support node (SGSN), a method for communicatively coupling said UMA device and said core network, said method comprising:
a) using a first protocol standard that carries audio data to communicatively couple said UNC and said UMA device;
b) relaying a subset of messages of the first protocol standard from the UNC to the core network, wherein said subset of messages are in a second protocol that is a subset of the first protocol;
c) wherein said first protocol standard comprises a set of messages for performing discovery and registration operations; and
d) wherein said relaying is without translation of said set of messages of the first protocol.

2. The method of claim 1, wherein said first protocol standard comprises a set of messages for handling voice, data, circuit switched domain signaling and packet switched domain signaling.

3. The method of claim 2, wherein said second protocol comprises a URR Discovery Request message, a URR Discovery Accept message and a URR Discovery Reject.

4. The method of claim 3, wherein said second protocol further comprises a URR Register Request message, a URR Register Accept message, a URR Register Reject.

5. The method of claim 4, wherein said second protocol further comprises a URR Register Redirect message, a URR Register Update Uplink message, a URR Register Update Downlink message, a URR Deregister message, a URR Keep Alive message and a URR Status message.

6. The method of claim 2, wherein said second protocol comprises:
a) a URLC Data message;
b) a URLC Activate UTC Request message;
c) a URLC Activate UTC Ack message; and
d) a URLC Deactivate UTC Request message.

7. The method of claim 2, wherein said second protocol comprises:
a) a URLC Unidata message;
b) a URLC DFC Request message; and
c) a URLC UFC Request message.

8. A system for handling communications between an unlicensed mobile access (UMA) network controller (UNC) and a licensed wireless communication system, said system comprising:
a) a mobile switching center (MSC) communicatively coupled to said UNC;
b) wherein the UNC and the MSC communicate utilizing a first subset of a first protocol standard message set wherein said first protocol standard message set comprises messages for handing discovery and registration, circuit switching domain and packet switching domain signaling, and circuit switching based data and packet switching based data; and
c) wherein said first subset is for handling circuit switched domain signals and circuit switching based data.

9. The system of claim 8, wherein a UMA device is communicatively coupled to said UNC using an IP network.

10. The system of claim 8, wherein said UNC further comprises a security gateway function and a control function.

11. The system of claim 10, wherein said security gateway function communicates with said MSC using a second subset of said first protocol standard message set, wherein said second subset is for handling circuit switched data.

12. The system of claim 11, wherein said circuit switched data comprises audio data.

13. The system of claim 16, wherein said control function is communicates with the MSC using a third subset of said first protocol standard message set, wherein said third subset if for handling circuit switched domain signaling.

14. A system for handling communications between an unlicensed mobile access (UMA) network controller (UNC) and a licensed wireless communication system, said system comprising:
a) a serving general packet radio service support node (SGSN) communicatively coupled to said UNC;
b) wherein the UNC and the SGSN communicate utilizing a first subset of a first protocol standard message set wherein said first protocol standard message set comprises messages for handing discovery and registration, circuit switching domain and packet switching domain signaling, and circuit switching based data and packet switching based data; and
c) wherein said first subset is for handling packet switched domain signals and packet switching based data.

15. The system of claim 14, wherein a UMA device is communicatively coupled to said UNC using an IP network.

16. The system of claim 14, wherein said UNC further comprises a security gateway function and a control function.

17. The system of claim 16, wherein said security gateway function communicates with said SGSN using a second subset of said first protocol standard message set, wherein said second subset is for handling packet switched data.

18. The system of claim 17, wherein said packet switched data comprises e-mail.

19. The system of claim 17, wherein said packet switched data comprises Internet data.

20. The system of claim 17, wherein said packet switched data comprises text message data.

21. The system of claim 16, wherein said control function communicates with said SGSN using a third subset of said first protocol standard message set, wherein said third subset if for handling packet switched domain signaling.
